(19) United States
(12) Patent Application Publication
(10) Pub. No.: US 2013/0254083 A1
(43) Pub. Date: Sep. 26, 2013

(54) Payment device policy management

(71) Applicants: Anne Louise Bolgert, Austin, TX (US); Richard Jay Cohen, Austin, TX (US); Randolph Michael Forlenza, Austin, TX (US); Raghuraman Kalyanaraman, Round Rock, TX (US); Suresh Vemulapalli Kumar, Austin, TX (US)

(72) Inventors: Anne Louise Bolgert, Austin, TX (US); Richard Jay Cohen, Austin, TX (US); Randolph Michael Forlenza, Austin, TX (US); Raghuraman Kalyanaraman, Round Rock, TX (US); Suresh Vemulapalli Kumar, Austin, TX (US)

(73) Assignee: INTERNATIONAL BUSINESS MACHINES CORPORATION, Armonk, NY (US)

(21) Appl. No.: 13/427,229

(22) Filed: Mar. 22, 2012

(51) Int. Cl. G06Q 40/00

(52) U.S. Cl. 705/35

(57) ABSTRACT

A method, apparatus and computer program product enables user-directed, selective control of payment transactions for a user's payment device. The techniques enable a payment device user to create and manage self-defined policies on how a particular payment device (tangible or intangible) may be used. This approach enables the end user, as opposed to the financial or commercial institution, to control transactions with respect to the account. Thus, for example, using a display interface, the account holder can control factors such as: allowed or disallowed vendors, a number of charges, timing of charges, a charge frequency, types of purchases allowed, and the amount charged. This fine-grained, device-specific control mechanism enables account holders to protect financial assets against fraudulent or improper activity. The approach provides a policy management system by which user-directed options for selectively controlling and restricting payment transactions may be realized, thereby providing better security and more customized account control.

### BACKGROUND OF THE INVENTION

1. Technical Field

This disclosure relates generally to account holder-based, user-directed control over transactions that may be implemented by or otherwise associated with a user's payment device.

2. Background of the Related Art

Payment devices come in many forms and have become ubiquitous. They may be physical, such as credit cards, debit cards, RFID devices with embedded payment chips, mobile devices with built-in or programmatic transaction systems, or the like, or they may be intangible, such as a PayPal® account, a user-accessible bank account, or the like. A payment device typically has an account holder (or “user”) associated therewith. Their scope of use has expanded significantly so as to become a factor in nearly every facet of personal and commercial everyday financial activity. Indeed, the convenience, universal acceptance, and portability of these devices are some of their most attractive features. They are used for all types of activities, from in-store and on-line purchases, charitable donations, automated bill and loan payments, rentals, cash withdrawals, groceries, fuel, restaurant meals, and the like. They involve billions of transactions per day, spanning many millions of users and vendors.

Despite their expanded usage and convenience, however, it is becoming increasingly difficult for users to control and limit the activity on their accounts. Presently, account holders of payment devices have few options to limit the type, payee, size, timing, or frequency of the transactions that may be initiated from or by using the device. Other than perhaps the setting of credit limits, the cardholder has little flexibility to place limits on transactions.

Doing business with on-line vendors can be risky. Once a vendor has the card holder's account information, an unscrupulous employee could make additional, unauthorized charges to the account. Similar to the risks associated with on-line vendors, an unscrupulous employee of a brick-and-mortar vendor could make additional, unauthorized charges with the account holder's information. Payment account information is periodically copied after use in restaurants and used for further transactions with other vendors. Payment account information is often associated with periodic, cyclical utility or entertainment vendors, such as cable TV or cell phone account. When the account holder terminates his or her business relationship with the vendor, however, it can be difficult to prevent the vendor from continuing to charge the card. Vendors offering auto-pay or cyclical accounts can arbitrarily increase charges or add obscured debits to user accounts without prior, or any, notification. It can be very difficult for the account holder to dispute these additional charges, and resolution and reimbursement can be time-consuming and costly.

Often, when the types of disputes and incidents described above occur, the payment account holder has no recourse other than canceling the account and having the account provider issue a new one. Financial recovery under these circumstances can be a very time-consuming process. The account holder must update his or her payment account information with each vendor with which they do business to reflect the new account. In addition, the disputed changes still must be identified and resolved, because canceling the account does not legally resolve the validity of liability issues. This requirement can degrade the account holder's credit rating and have other negative financial impacts.

### BRIEF SUMMARY OF THE INVENTION

A method, apparatus and computer program product enables user-directed, selective control of payment transactions for a user's payment device. The techniques described herein enable a payment device user to create and manage his or her self-defined policies on how a particular payment device (tangible or intangible) may be used. This approach enables the end user of the device, as opposed to the financial or commercial institution, to control transactions with respect to the account. Thus, for example, using a display interface, the account holder can control factors such as, without limitation: allowed or disallowed vendors, a number of charges, timing of charges, a charge frequency, types of purchases allowed, and the amount charged. This fine-grained, device-specific control mechanism enables account holders to protect their financial assets against fraudulent or other improper activity. The approach provides a policy management system by which user-directed options for selectively controlling and restricting the scope of payment transactions may be realized, thereby providing better security and more customized control of accounts.

In one embodiment, a method of user-directed transaction policy management for a user's payment device is implemented in a data processing system.

According to another embodiment, the method is performed in a policy change management apparatus. The apparatus comprises a processor, and computer memory that holds computer program instructions executed by the processor to carry out the method.

According to still another aspect, the above-described method is performed by a computer program product in a computer readable medium for use in policy change management system. The computer program product holds computer program instructions which, when executed by the data processing system, perform the method.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a known transaction processing solution with which the subject matter of this disclosure may be associated;

FIG. 4 illustrates a display interface Policy Setting page for use by an account holder to establish a custom payment device policy according to this disclosure;

FIG. 5 illustrates a representative General Settings page for use by the account holder;

FIG. 6 illustrates a representative Vendor Specific page for use by the account holder to define and manage a unique policy for a specific vendor;

FIG. 7 illustrates a representative display interface page from which the payment device policy management function may be reached from an account provider web page; and

FIG. 8 illustrates a policy management system in which the techniques of this disclosure may be implemented.

### DETAILED DESCRIPTION OF AN ILLUSTRATIVE EMBODIMENT

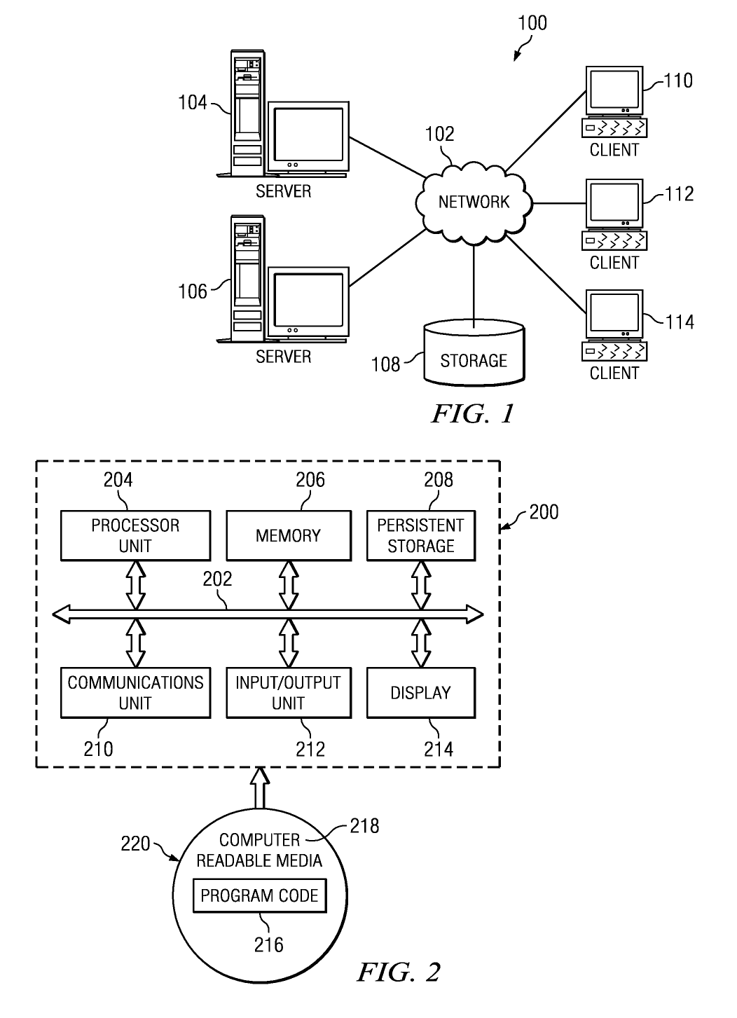

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++, C#, Objective-C or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

As is also well-known, transaction processing that occurs interactively with the end user is referred to as online transaction processing or OLTP. By way of additional background (as context for the disclosed subject matter), one of the main characteristics of a transaction system is that the interactions between the user and the system are very short. The user performs a complete business transaction through short interactions, with immediate response time required for each interaction. These types of systems are currently supporting mission-critical applications; therefore, continuous availability, high performance, and data protection and integrity are required. Online transactions are familiar to most people. Examples include: ATM machine transactions such as deposits, withdrawals, inquiries, and transfers, supermarket payments with debit or credit cards, purchase of merchandise over the Internet, and the like. For example, inside a bank branch office or on the Internet, customers are using online services when checking an account balance or directing fund balances. In fact, an online system of this type typically performs many of the same functions as an operating system: managing and dispatching tasks, controlling user access authority to system resources, managing the use of memory, managing and controlling simultaneous access to data files, and providing device independence. Some industry uses of mainframe-based online systems include: banks—ATMs, teller systems for customer service; Insurance—agent systems for policy management and claims processing; Travel and transport—Airline reservation systems; Manufacturing—Inventory control, production scheduling; Government—Tax processing, license issuance and management, and so forth.

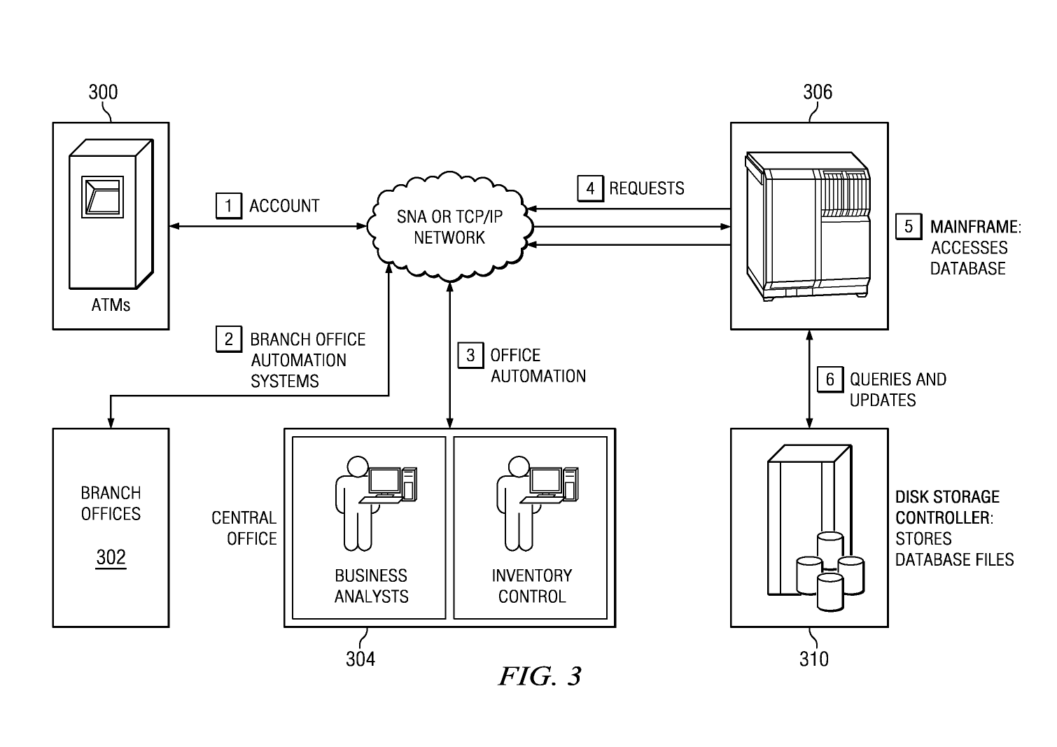

FIG. 3 illustrates a representative online transaction processing (OLTP) system that is known in the prior art. In a bank branch office, for example, customers use online services when checking an account balance or making an investment. FIG. 3 shows a series of common online transactions using a mainframe. At step 1, a customer uses an ATM 300, which presents a user-friendly interface for various functions: withdrawal, query account balance, deposit, transfer, or cash advance from a credit card account. At step 2, and perhaps elsewhere in the same private network, a bank employee in a branch office 302 performs operations, such as consulting, fund applications, and money ordering. At step 3, at the bank's central office 304, business analysts tune transactions for improved performance, and other staff use specialized online systems for office automation to perform customer relationship management, budget planning, and stock control. At step 4, requests such as described are directed to the mainframe computer 306 for processing. A representative mainframe computer may be implemented using IBM zOS®. At step 5, programs running on the mainframe computer perform updates and inquiries to the database management system (for example, IBM DB2®). At step 6, specialized disk storage systems 310 store the database files.

The above-described transaction system is merely representative. There is no requirement that such a system include a mainframe computer. Other known transaction systems include web server-based front-ends, application server-back-ends, databases, and the like. Other well-known devices for interfacing with such systems include, without limitation, a web browser (for online shopping), a credit card device, a mobile device, or the like.

### Payment Device Policy Management

With the above as background, the subject disclosure is now described. As noted above, this disclosure provides a system and method for account holder, consumer-controlled, policy management of payment devices. As used herein, a “policy” may refer to a single policy, or a set of policies (a “policy set”). A “payment device” may be any type of device, card, account, program, process or the like that is used to facilitate a transaction involving units of monetary or other value. Representative payment devices may be physical, such as credit cards, debit cards, RFID devices with embedded payment chips, mobile devices with built-in or programmatic transaction systems or applications, or the like, or they may be intangible, such as a PayPal® account, a user-accessible bank account, or the like. A payment device has an account holder (or “user”) associated therewith. According to this disclosure, the payment device user—as opposed to a commercial or other entity with which the account is associated—creates and manages his or her self-defined policies on how a particular payment device (tangible or intangible) may be used. This approach enables the end user of the device, as opposed to the financial or commercial institution, to control one or more transactions with respect to the account. In a representative, but non-limiting embodiment, an account provider enables an account holder to create and manage his or her own user-defined payment device transaction policies. A single policy may be applied for each payment device, or for a set of such devices.

Representative user interfaces for the payment device policy management system are now described. These display interfaces are provided by a payment device policy management system, and they may be implemented in a conventional manner, such as a web-based graphical user interface (GUI), a command line interface (CLI), a standalone device-specific application, or the like. In one embodiment, the display interfaces are implemented in a desktop machine, such as described in FIG. 2 above. In an alternative, the interfaces are implemented in a mobile device, such as a wireless client device (e.g., a cellphone, a personal digital assistant, a mobile computer with a smartphone client, or the like) that is capable of sending and receiving data in a wireless manner using a wireless protocol. In the context of a mobile device, the interfaces may be provided using a client server-based protocol (such as shown in FIG. 1), via a dedicated mobile- or tablet-based application, or in any other known manner. Typically, an end user is permitted to access his or her policy management interface screens following appropriate authentication and authorization, typically over secure (e.g., SSL or the like) connections. Such authentication schemes (e.g., single-sign-on, basic authentication using user identifier/password) are well-known in the prior art. Of course, account access methodologies differ according to the account provider, but the subject disclosure assumes that the user can obtain access to his or her account information to facilitate the policy definition and management.

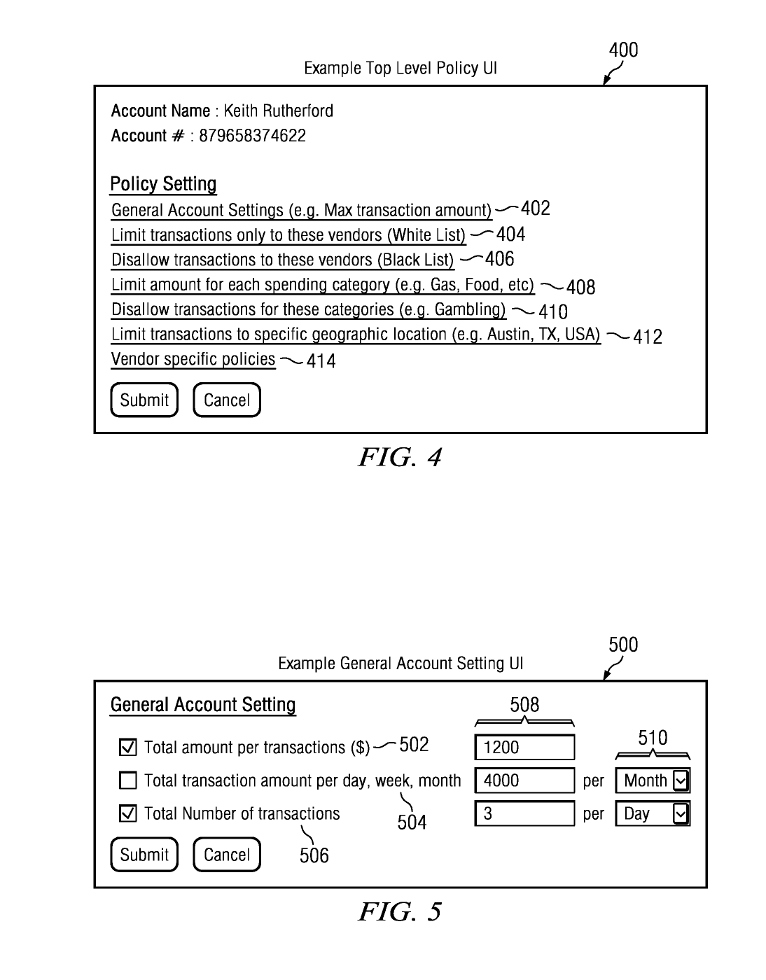

FIG. 4 illustrates a representative Policy Setting interface 400, which is preferably implemented as a web-based interface (as a set of web pages, or their equivalent, depending on the device display characteristics). The interface 400 identifies the user and his or her account number, and a set of one or more user-navigation links are provided. A first link 402 links the user to his or her General Account Settings page. As used herein, a “page” refers to a web page or document (irrespective of the format), an application, or the like. A second link 404 links the user to a page by which he or she can identify those vendors who are permitted to receive payments (a “white list”). A third link 406 links the user to a page by which he or she can identify those vendors who are not permitted to received payments (a “black list”). A fourth link 408 links the user to a page by which he or she can limit the amounts that may be charged for each of one or more spending categories, such as gas, food, entertainment, and the like. A fifth link 410 links the user to a page by which he or she can disallow transactions for certain spending categories, such as gambling, and so forth. A sixth link 412 links the user to a page by which the user can limit transactions to specific geographic locations (e.g., Austin, Tex.). A seventh link 414 provides a link to one or more vendor-specific policies that the user may define and enforce for a specific payment device. The particular order of the links is merely representative, as are the particular contents of each link. Using one or more these links and the associated pages, a user defines his or her own custom policy for the one or more payment device(s) that the user desires to configure using the payment device policy management system of this disclosure.

FIG. 5 illustrates a representative General Account Setting page 500 that is reached when the user selects the first link 402 in the display interface. The General Account Setting page comprises a number of fields that may be selected for configuration including, without limitation, a “Total amount per transaction” 502, a “Total transaction amount per day, week or month” 504, and a “Total Number of transactions” 506. Other fields and permissions/restrictions may be included. Fill-in fields 508 and drop-down lists are provided to enable the desired payment device policy data to be entered and otherwise updated as desired. Once the data is entered, the user can “Submit” or “Cancel” the general account policy settings using the identified buttons.

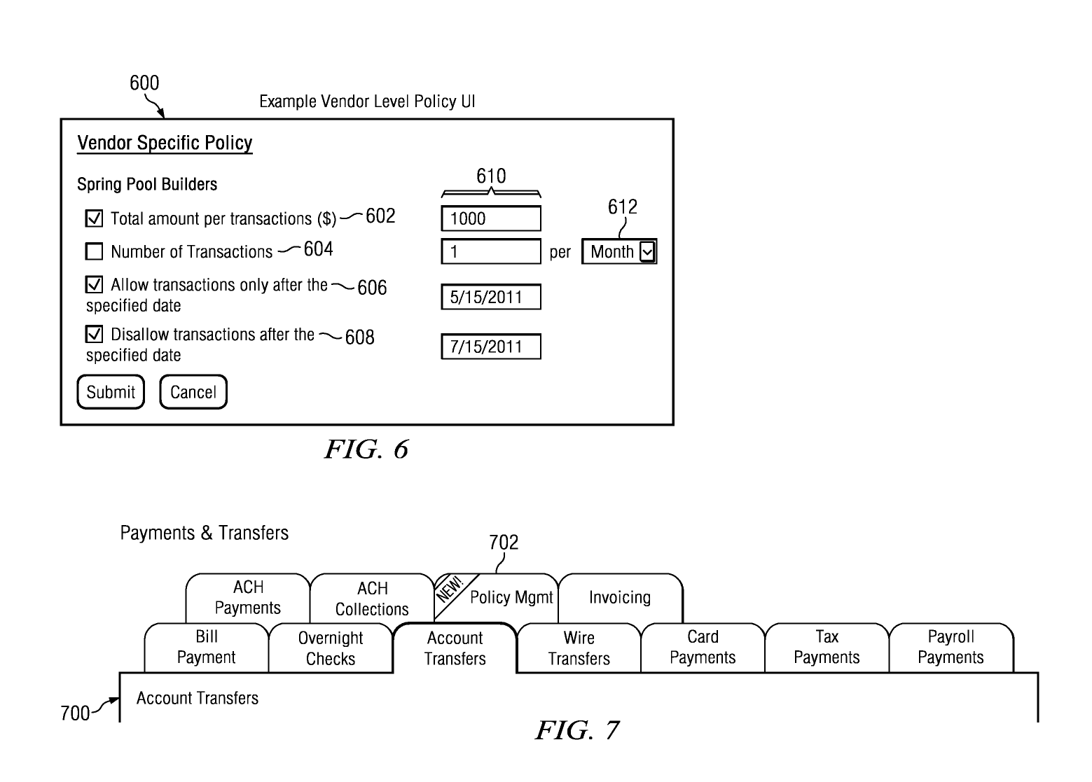

FIG. 6 illustrates a representative vendor specific policy for a user-defined vendor (in this case, “Spring Pool Builders.”) This Vendor Specific Policy page comprises a number of fields that may be selected for configuration including, without limitation, a Total amount per transaction 602, a Number of Transactions 604, an option to “Allow transactions only after a specified date” 606, and an option to “Disallow transactions after a specified date” 608, and so forth. Other fields and permissions/restrictions may be included. Fill-in fields 610 and drop-down lists are provided to enable the desired payment device policy data to be entered and otherwise updated as desired. Once the data is entered, the user can “Submit” or “Cancel” the vendor specific policy using the identified buttons.

In this manner, and using similar display interfaces for the other above-identified functions (e.g., defining and managing a vendor white list, defining and managing a vendor black list, defining and managing a spending category limit, defining and managing a spending category black list, defining and managing a geographic location white list, and so forth), the user defines (configures) and manages a payment device policy for one or more payment devices associated with the user. A policy management system that implements this methodology enables the user to establish transaction policies comprised of any combination of the above and other criteria as required or desired. Using a conventional display editor, the user may even define his or her own custom policies.

Moreover, other types of GUI widgets (such as date pickers, list builders, search forms, sliders, scrollbars, drop-down lists, radio buttons, and the like) may be used (in lieu of the fill-in fields) to receive the data being entered.

In a representative embodiment, a payment device policy management function is made available to an end user via his or her online banking web site. FIG. 7 illustrates a portion of an SSL-protected web page 700 that includes a “Policy Management” tab 702 for this purpose. Upon selection of the tab 702, the Policy Setting page (as previously described) in presented to the end user.

In an alternative embodiment, the payment device policy management system is implemented as a Web site, an https-accessible Web service, a cloud-based service, a federated service, a standalone application, or the like. Depending on implementation, the policy management system may interoperate with other systems using conventional mechanisms including, without limitation, database queries (via JDBC/JPA/ADO), SOAP/HTTP-based web services, remote procedure calls (RPC), application programming interfaces (API) and the like.

The above-described technique may be applied to any, and all, types of payment devices which are used to convey financial assets from one entity to another. To support this system and methodology, the account holder simply accesses his or her accounts (via a multitude of mechanisms, such as online, cell- or smart-phone, kiosk, and so forth), navigates to the policy management display interface, and then establishes the desired policy. Preferably, and as described, the account holder logs-on over a secure protocol to access the account and the policy management display interface of this disclosure.

Using the display interface as described, the user creates and manages his or her custom payment device transaction policy. A particular policy may have any number of attributes and values associated with those attributes including, without limitation: limit transactions to a specific set of vendors, disallow transaction to specific vendors, limit the total amount per transaction, limit the total amount per transaction per vendor, limit a particular vendor to a maximum for all transactions, limit the total transaction amount per day, week, month, etc., per vendor, limit the total transaction amount per day, week, month, etc. for the account, limit transactions for a specific vendor to a specific number of transactions over a given time period. e.g., once a month, once a week, set a maximum time span for valid transaction such as two weeks, limit transactions to a one time purchase, within a specified time span, limit transactions to a one time purchase, up to a maximum amount, within a specified time span, allow transactions only after a specific date has passed, disallow transactions after a specific date has passed, limit the amount for a specific vendor per transaction, limit amount for a specific category of purchase, disallow certain types of transactions such as credit card charges to adult phone sites, limit transactions to specific geographical locations, e.g., city, county, state, country, zip code, and many others. Indeed, using a policy editor tool (e.g., a WYSIWIG editor), the user can create completely custom restrictions as he or she deems fit for the particular account.

The above-identified list of policy attributes is merely representative, but they will be typical.

While implementation using policy management display interfaces is a preferred technique for creating the payment device transaction policy, this is not a limitation, as the policy may be defined programmatically or in some other system- or user-specified manner.

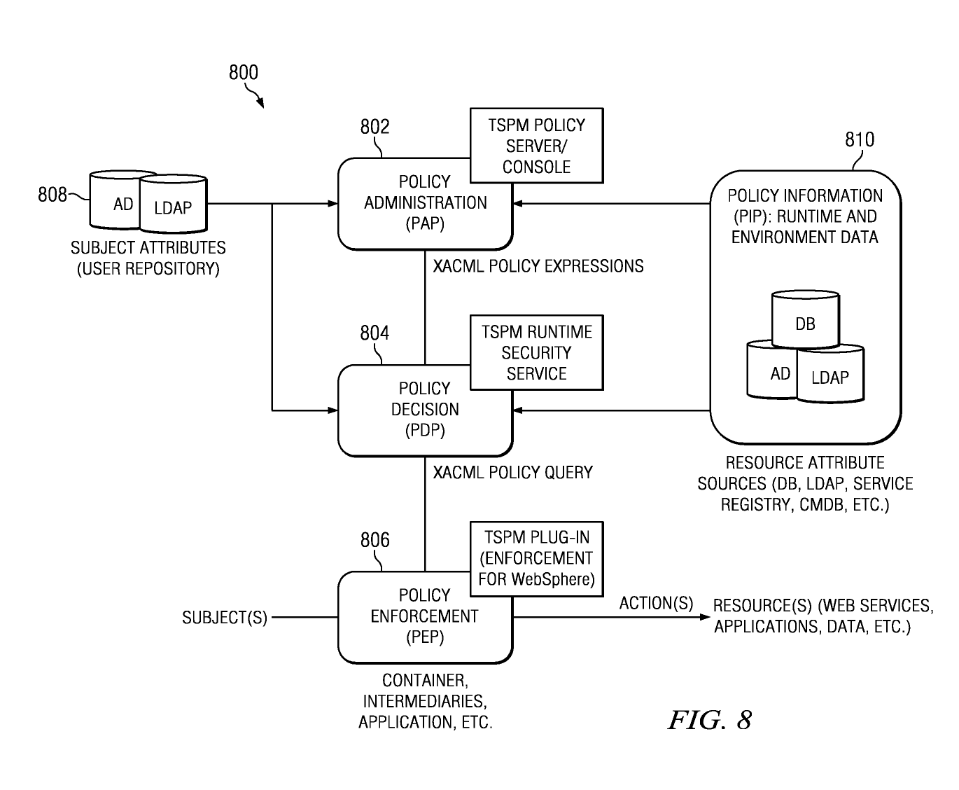

FIG. 8 illustrates a representative policy management system 800 in which the above-described technique may be implemented. The system 800 may be implemented across one or more machines operating in a computing environment, such as shown in FIG. 1. Typically, the system comprises a policy administration point (PAP) 802, a policy decision point (PDP) 804, and a policy enforcement point (PEP) 806. Generally, the policy administration point 802 is used to define a payment device transaction policy, which may be specified as a set of XACML policy expressions. This policy uses subject attributes provided from a user repository 808, as well runtime and environment data received from policy information point (PIP) 810. The policy decision point (PDP) 804 receives similar information and responds to an XACML policy query received from the policy enforcement point (PEP) 806 to enforce the policy on a subject and with respect to a particular action initiated by the subject. In one commercial implementation of this approach, the PAP 802 is implemented by IBM® Tivoli® Security Policy Manager (TSPM) policy service/console, the PDP 804 is implemented in the TSPM runtime security service, and the PEP is implemented as a TSPM plug-in to WebSphere® Application Server. In this embodiment, which is merely illustrative, the policy definition and management technique is implemented within the policy administration point.

Those skilled in the art will appreciate that other implementations and use cases for the policy management system also are within the scope of this disclosure.

One or more of such components (or “functions”) may be combined with one another, and the nomenclature used here is merely intended for exemplary purposes. Each such component typically is implemented in software, as a set of computer program instructions, executable on one or more processors, to comprise a special-purpose computing entity or machine. In the alternative, a particular component is implemented as a machine, device, system, process, program or execution thread. A component typically includes or has associated therewith one or more data sets. Such components and data typically are stored in computer memory or one or more data stores.

The subject matter described herein has many advantages. Primarily, the system and method described provides an account holder a significant degree of control over how a particular payment device may be used. The approach provides a robust and scalable solution that enables the account holder to manage his or her payment device uniquely. Using the approach, an account holder (or, more generally, a device user) can control factors such as, without limitation, allowed vendors, number of charges, timing of charges, frequency of charges, types of purchases allowed, location of allowed charges, location of disallowed charges, and the amount(s) charged. In this manner, the policy management system enables account holders to protect their financial assets against unauthorized activities.

The functionality described above may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed invention are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. The techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the policy association functionality described herein can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the policy definition and visualizations described above are implemented in a special purpose computer, preferably in software executed by one or more processors. The software is maintained in one or more data stores or memories associated with the one or more processors, and the software may be implemented as one or more computer programs. Collectively, this special-purpose hardware and software comprises or supplements an existing policy management solution, as has been described

In an alternative embodiment, a policy management central management console exposes one or more web-based interfaces that may be used to create and/or modify a policy, and/or to visualize the policy relationships in the manner described.

As noted, the described functionality may be implemented as an adjunct or extension to an existing policy management solution. The particular policies identified in the examples are merely representative and should not be taken to limit the disclosed subject matter.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Any application or functionality described herein may be implemented as native code, by providing hooks into another application, by facilitating use of the mechanism as a plug-in, by linking to the mechanism, and the like.

The techniques disclosed herein are not limited to any particular implementation, although typically the approach is based on a web server, an application server, a middleware policy management appliance or system, or the like. As noted, the above-described policy association function may be used in any system, device, portal, site, or the like wherein it is desired to enable an account holder (or, more generally, a payment device user) to create and manage account usage policies. The policy management method is implemented in, or in association with, a tangible machine having at least one hardware element (e.g., a processor, a computer memory or data store, a non-transitory computer-readable medium, or the like).

Having described our invention, what we now claim is as follows:

1-8. (canceled)

9. Apparatus for policy creation and management, comprising:
a processor;
computer memory holding computer program instructions that when executed by the processor perform a method for user-directed, selective control of payment transactions, the method comprising:
upon receipt of a request, providing a permitted user access to a user interface associated with a policy management system, the policy management system having a hardware element;
receiving, via one or more display screens associated with the user interface, configuration data by which the permitted user defines a user-specific, payment device-specific transaction policy; and
enforcing the user-specific, payment device-specific transaction policy with respect to particular transaction account associated with the user.

10. The apparatus as described in claim 9 wherein the configuration data limits transactions to a first user-specified set of vendors, or disallows transactions with respect to a second user-specified set of vendors.

11. The apparatus as described in claim 9 wherein the configuration data limits transactions to a first user-specified set of categories, or disallows transactions with respect to a second user-specified set of categories.

12. The apparatus as described in claim 9 wherein the configuration data limits transactions to a first user-specified set of geographic locations, or disallows transactions with respect to a second user-specified set of geographic locations.

13. The apparatus as described in claim 9 wherein the configuration data limits a total amount per transaction.

14. The apparatus as described in claim 9 wherein the configuration data limits a number of transactions per vendor, optionally over a configurable period of time.

15. The apparatus as described in claim 9 wherein the configuration data limits transactions to a one-time purchase or transaction amount, optionally within a configurable period of time.

16. The apparatus as described in claim 9 wherein the configuration data defines a vendor-specific transaction policy.

17. A computer program product in a computer readable medium for policy creation and management in a data processing system, the computer program product holding computer program instructions which, when executed by the data processing system, perform a method for user-directed, selective control of payment transactions, the method comprising:
upon receipt of a request, providing a permitted user access to a user interface associated with a policy management system, the policy management system having a hardware element;
receiving, via one or more display screens associated with the user interface, configuration data by which the permitted user defines a user-specific, payment device-specific transaction policy; and
enforcing the user-specific, payment device-specific transaction policy with respect to particular transaction account associated with the user.

18. The computer program product as described in claim 17 wherein the configuration data limits transactions to a first user-specified set of vendors, or disallows transactions with respect to a second user-specified set of vendors.

19. The computer program product as described in claim 17 wherein the configuration data limits transactions to a first user-specified set of categories, or disallows transactions with respect to a second user-specified set of categories.

20. The computer program product as described in claim 17 wherein the configuration data limits transactions to a first user-specified set of geographic locations, or disallows transactions with respect to a second user-specified set of geographic locations.

21. The computer program product as described in claim 17 wherein the configuration data limits a total amount per transaction.

22. The computer program product as described in claim 17 wherein the configuration data limits a number of transactions per vendor, optionally over a configurable period of time.

23. The computer program product as described in claim 17 wherein the configuration data limits transactions to a one-time purchase or transaction amount, optionally within a configurable period of time.

24. The computer program product as described in claim 17 wherein the configuration data defines a vendor-specific transaction policy.
